(19) United States
(12) Patent Application Publication
(10) Pub. No.: US 2026/0196504 A1
(43) Pub. Date: Jul. 9, 2026

(54) POSITIVE ELECTRODE PLATE, ELECTROCHEMICAL APPARATUS, AND AN ELECTRONIC APPARATUS

(71) Applicant: NINGDE AMPEREX TECHNOLOGY LIMITED, Ningde (CN)

(72) Inventors: Taosheng WANG, Ningde (CN); Changming QU, Ningde (CN)

(73) Assignee: NINGDE AMPEREX TECHNOLOGY LIMITED, Ningde (CN)

(21) Appl. No.: 19/444,792

(22) Filed: Jan. 9, 2026

(30) Foreign Application Priority Data
Jan. 9, 2025 (CN) 202510034212.X

(51) Int. Cl. H01M 4/58; H01M 4/02; H01M 4/131; H01M 4/36; H01M 4/62

(52) U.S. Cl. CPC H01M 4/5825; H01M 4/131; H01M 4/366; H01M 4/622; H01M 2004/021; H01M 2004/028

(57) ABSTRACT

A positive electrode plate includes a positive electrode current collector, a first coating layer, and a positive electrode material layer. The first coating layer is disposed on a surface of the positive electrode current collector, and the positive electrode material layer is disposed on a surface of the first coating layer facing away from the positive electrode current collector. The first coating layer includes a lithium-containing material and a conductive material. The lithium-containing material has a Dᵥ99 of 500 nm to 1000 nm, and the lithium-containing material has a specific surface area of 5 m²/g to 50 m²/g.

### CROSS REFERENCE TO RELATED APPLICATIONS

This application claims priority to the Chinese Patent Application Ser. No. 202510034212.X, filed on Jan. 9, 2025, the disclosure of which is hereby incorporated by reference in its entirety.

### TECHNICAL FIELD

This application relates to the technical field of electrochemistry, in particular to a positive electrode plate, an electrochemical apparatus, and an electronic apparatus.

### BACKGROUND

Electrochemical apparatuses (for example, lithium-ion batteries) have entered our daily life with the advancement of technology and increasing requirements on environmental protection. With the widespread use of lithium-ion batteries, their cycling performance has attracted increasing attention from users, and consumers, after-sales services, and manufacturers have also put forward new requirements on the safety performance of lithium-ion batteries.

However, current technologies for improving the safety performance of lithium-ion batteries are not yet mature. During use, internal short circuits often occur because a positive electrode plate and a negative electrode plate come into contact with each other during nail penetration, or the positive electrode plate and the negative electrode plate are connected through a nail, thereby affecting the safety performance of the lithium-ion battery and also reducing the cycling performance. Therefore, there is an urgent need in the market for a lithium-ion battery with excellent safety performance and cycling performance.

### SUMMARY

An objective of this application is to provide a positive electrode plate, an electrochemical apparatus, and an electronic apparatus, so as to improve the safety performance and cycling performance of the electrochemical apparatus.

It should be noted that in the summary of this application, a lithium-ion battery serving as an electrochemical apparatus is used as an example to explain this application, but the electrochemical apparatus of this application is not limited to a lithium-ion battery. Specific technical solutions are as follows.

A first aspect of this application provides a positive electrode plate. The positive electrode plate includes a positive electrode current collector, a first coating layer, and a positive electrode material layer. The first coating layer is disposed on a surface of the positive electrode current collector, and the positive electrode material layer is disposed on a surface of the first coating layer facing away from the positive electrode current collector. The first coating layer includes a lithium-containing material and a conductive material. The lithium-containing material has a Dᵥ99 of 500 nm to 1000 nm, and the lithium-containing material has a specific surface area of 5 m²/g to 50 m²/g. In this application, by providing the first coating layer on the positive electrode plate and controlling the Dᵥ99 and specific surface area of the lithium-containing material within the above ranges, short-circuit points caused by contact between the positive electrode plate and a negative electrode plate during a nail penetration test can be reduced, short-circuit resistance generated when a short circuit occurs in the electrochemical apparatus can be increased, heat generation power during a short circuit can be reduced, contact between the positive electrode current collector and the first coating layer as well as contact between the positive electrode current collector and the positive electrode material layer can be improved, and electron transport in the positive electrode plate can be facilitated, thereby improving the safety performance and cycling performance of the electrochemical apparatus.

In an embodiment of this application, the lithium-containing material has a Dᵥ99 of 500 nm to 700 nm. The Dᵥ99 of the lithium-containing material being within the above range is conducive to further improving the safety performance and cycling performance of the electrochemical apparatus.

In an embodiment of this application, the lithium-containing material has a specific surface area of 30 m²/g to 50 m²/g. The specific surface area of the lithium-containing material being within the above range is conducive to further improving the safety performance and cycling performance of the electrochemical apparatus.

In an embodiment of this application, the lithium-containing material satisfies at least one of the following conditions: (1) the lithium-containing material has a Dᵥ50 of 50 nm to 200 nm; or (2) the lithium-containing material has a powder resistivity of 50 Ω·cm to 100 Ω·cm. The lithium-containing material satisfying the above characteristics is conducive to improving the safety performance and cycling performance of the electrochemical apparatus.

In an embodiment of this application, the lithium-containing material includes at least one of lithium iron phosphate, lithium cobalt oxide, lithium manganese iron phosphate, or lithium silicate; and based on a mass of the first coating layer, a mass percentage of the lithium-containing material is 50% to 70%. Selecting the above lithium-containing material and controlling its mass percentage within the range provided in this application is more conducive to supplementing active lithium lost due to formation of a solid electrolyte interface film (SEI film) during initial charge-discharge and active lithium consumed during cycling, improving the initial coulombic efficiency and energy density of the electrochemical apparatus, reducing cycling capacity decay, also facilitating formation of a denser and more uniform first coating layer on a surface of the positive electrode current collector, and enhancing the protective effect on the positive electrode current collector during a nail penetration test, thereby helping to improve the safety performance and cycling performance of the electrochemical apparatus.

In an embodiment of this application, the conductive material includes at least one of SnO₂, In₂O₃, CoO, TiO₂, or Cr₂O₃; and based on a mass of the first coating layer, a mass percentage of the conductive material is 20% to 45%. Selecting the above conductive material and controlling its mass percentage within the range provided in this application facilitates formation of a uniform conductive network between the positive electrode material layer and the positive electrode current collector, improving electron transport in the positive electrode plate, and reducing interfacial contact impedance during cycling, thereby helping to improve the safety performance and cycling performance of the electrochemical apparatus.

In an embodiment of this application, the conductive material further includes a doping element; the doping element includes at least one of Sb, F, or B; and based on a mass of the conductive material, a mass percentage of the doping element is 0.5% to 5%. When the conductive material includes the above doping element and the mass percentage of the doping element is controlled within the range provided in this application, the first coating layer can protect the positive electrode current collector and can also reduce the powder resistivity of the conductive material, which is more conducive to forming a uniform conductive network between the positive electrode material layer and the positive electrode current collector and improving electron transport in the positive electrode plate, thereby helping to improve the safety performance and cycling performance of the electrochemical apparatus.

In an embodiment of this application, based on the mass of the conductive material, the mass percentage of the doping element is 0.5% to 2%. Controlling the mass percentage of the doping element in the conductive material within the above range allows the first coating layer to protect the positive electrode current collector, also helps to reduce the powder resistivity of the conductive material, and improves electron transport in the positive electrode plate, thereby further improving the safety performance and cycling performance of the electrochemical apparatus.

In an embodiment of this application, the conductive material satisfies at least one of the following conditions: (1) the conductive material has a Dᵥ50 of 50 nm to 200 nm; or (2) the conductive material has a powder resistivity of 5 Ω·cm to 20 Ω·cm. The conductive material satisfying the above characteristics is conducive to improving the safety performance and cycling performance of the electrochemical apparatus.

In an embodiment of this application, the first coating layer further includes a first binder; the first binder includes a water-soluble metal salt compound; and based on a mass of the first coating layer, a mass percentage of the first binder is 5% to 10%. Selecting the above material for the first binder and controlling the mass percentage of the material within the range provided in this application is conducive to electron and ion transport in the positive electrode plate, improves the kinetic performance of the electrochemical apparatus, and enhances the tensile strength of the first coating layer. Strong interaction between the first coating layer and the positive electrode current collector is also conducive to enhancing adhesion force between the first coating layer and the positive electrode current collector as well as cohesion of the first coating layer, thereby helping to improve the safety performance and cycling performance of the electrochemical apparatus.

In an embodiment of this application, the water-soluble metal salt compound includes an alkali metal polyacrylate salt and/or an alkaline earth metal polyacrylate salt, the alkali metal polyacrylate salt includes at least one of sodium polyacrylate, lithium polyacrylate, or potassium polyacrylate, and the alkaline earth metal polyacrylate salt includes at least one of calcium polyacrylate or magnesium polyacrylate. Selecting the above water-soluble metal salt compound is more conducive to improving electron and ion transport in the positive electrode plate, improves the kinetic performance of the electrochemical apparatus, and enhances the tensile strength of the first coating layer. Interaction with the positive electrode current collector enhances adhesion force between the first coating layer and the positive electrode current collector as well as cohesion of the first coating layer, thereby further improving the safety performance and cycling performance of the electrochemical apparatus.

In an embodiment of this application, the first coating layer has a thickness of 0.5 μm to 2 μm, and the first coating layer has a porosity of 10% to 20%. When the thickness and porosity of the first coating layer are within the ranges provided in this application, the first coating layer is relatively dense and uniform and has high mechanical strength, can protect the positive electrode current collector during a nail penetration test, reduce occurrence of internal short circuits in the electrochemical apparatus, and reduce the probability of thermal runaway caused by local overheating of the electrochemical apparatus. In addition, the positive electrode plate has low resistance, which is conducive to electron transport in the positive electrode plate, thereby improving the safety performance and cycling performance of the electrochemical apparatus while the electrochemical apparatus has high volumetric energy density.

In an embodiment of this application, the first coating layer has a thickness of 0.5 μm to 1 μm. The thickness of the first coating layer being within the range provided in this application is more conducive to increasing the volumetric energy density of the electrochemical apparatus and reducing resistance of the positive electrode plate, and the electrochemical apparatus also has excellent safety performance and cycling performance.

In an embodiment of this application, an adhesion force between the first coating layer and the positive electrode current collector is 500 N/m to 2000 N/m. When the adhesion force between the first coating layer and the positive electrode current collector is within the range provided in this application, good adhesion between the first coating layer and the positive electrode current collector can reduce occurrence of internal short circuits in the electrochemical apparatus, alleviate deformation of the positive electrode current collector during cycling, improve contact between the positive electrode current collector and the first coating layer and contact between the positive electrode current collector and the positive electrode material layer, and facilitate electron transport in the positive electrode plate, thereby improving the safety performance and cycling performance of the electrochemical apparatus.

In an embodiment of this application, the adhesion force between the first coating layer and the positive electrode current collector is 500 N/m to 1000 N/m. The adhesion force between the first coating layer and the positive electrode current collector being within the range provided in this application is conducive to improving the safety performance and cycling performance of the electrochemical apparatus.

A second aspect of this application provides an electrochemical apparatus. The electrochemical apparatus includes the positive electrode plate in any one of the foregoing embodiments. The electrochemical apparatus of this application has excellent safety performance and cycling performance.

A third aspect of this application provides an electronic apparatus. The electronic apparatus includes the electrochemical apparatus in any one of the foregoing embodiments. The electronic apparatus of this application has a long service life and excellent performance.

Beneficial effects of this application are as follows.

This application provides a positive electrode plate, an electrochemical apparatus, and an electronic apparatus. The positive electrode plate includes a positive electrode current collector, a first coating layer, and a positive electrode material layer. The first coating layer is disposed on a surface of the positive electrode current collector, and the positive electrode material layer is disposed on a surface of the first coating layer facing away from the positive electrode current collector. The first coating layer includes a lithium-containing material and a conductive material. The lithium-containing material has a Dᵥ99 of 500 nm to 1000 nm, and the lithium-containing material has a specific surface area of 5 m²/g to 50 m²/g. In this application, by providing the first coating layer on the positive electrode plate and controlling the Dᵥ99 and specific surface area of the lithium-containing material within the above ranges, short-circuit points caused by contact between the positive electrode plate and the negative electrode plate during a nail penetration test can be reduced, short-circuit resistance generated when a short circuit occurs in the electrochemical apparatus can be increased, heat generation power during a short circuit can be reduced, contact between the positive electrode current collector and the first coating layer and the positive electrode material layer can be improved, and electron transport in the positive electrode plate can be facilitated, thereby improving the safety performance and cycling performance of the electrochemical apparatus.

Certainly, implementing any product or method of this application does not necessarily need to achieve all the advantages described above at the same time.

### BRIEF DESCRIPTION OF DRAWINGS

To illustrate the technical solutions in some embodiments of this application or in the prior art more clearly, the following briefly describes the drawings used in some embodiments or the prior art. Apparently, the drawings described below are merely some embodiments of this application, and a person of ordinary skill in the art may still derive other drawings from these drawings without creative efforts.

FIG. 1 is a schematic structural diagram of a positive electrode plate according to an embodiment of this application along a thickness direction thereof.

Reference numerals: positive electrode current collector 11, first coating layer 12, and positive electrode material layer 13.

### DETAILED DESCRIPTION

The following clearly describes the technical solutions in some embodiments of this application. Apparently, the described embodiments are merely some embodiments rather than all embodiments of this application. All other embodiments obtained by a person of ordinary skill in the art based on this application without creative efforts shall fall within the protection scope of this application.

It should be noted that in specific embodiments of this application, a lithium-ion battery serving as an electrochemical apparatus is used as an example to explain this application, but the electrochemical apparatus of this application is not limited to a lithium-ion battery.

A first aspect of this application provides a positive electrode plate. The positive electrode plate includes a positive electrode current collector, a first coating layer, and a positive electrode material layer. The first coating layer is disposed on a surface of the positive electrode current collector, and the positive electrode material layer is disposed on a surface of the first coating layer facing away from the positive electrode current collector. The first coating layer includes a lithium-containing material and a conductive material. The lithium-containing material has a Dᵥ99 of 500 nm to 1000 nm, preferably 500 nm to 700 nm; and the lithium-containing material has a specific surface area of 5 m²/g to 50 m²/g, preferably 30 m²/g to 50 m²/g. For example, the Dᵥ99 of the lithium-containing material may be 500 nm, 550 nm, 600 nm, 650 nm, 700 nm, 750 nm, 800 nm, 850 nm, 900 nm, 950 nm, 1000 nm, or a range defined by any two of these values; and the specific surface area of the lithium-containing material may be 5 m²/g, 10 m²/g, 15 m²/g, 20 m²/g, 25 m²/g, 30 m²/g, 35 m²/g, 40 m²/g, 45 m²/g, 50 m²/g, or a range defined by any two of these values.

The positive electrode plate of this application is provided with the first coating layer, which can reduce short-circuit points caused by contact between the positive electrode plate and the negative electrode plate during a nail penetration test, increase short-circuit resistance generated when a short circuit occurs in the electrochemical apparatus, reduce heat generation power during a short circuit, reduce deformation of the positive electrode current collector caused by volume expansion of the positive electrode plate due to phase change of a positive electrode active material, improve contact between the positive electrode current collector and the first coating layer and contact between the positive electrode current collector and the positive electrode material layer, and promote electron transport in the positive electrode plate, thereby improving the safety performance and cycling performance of the electrochemical apparatus. The conductive material included in the first coating layer has good dispersibility and stability in a first coating layer slurry, which is conducive to uniform distribution in the first coating layer, thereby forming a uniform conductive network between the positive electrode material layer and the positive electrode current collector, improving electron transport in the positive electrode plate, reducing interfacial contact impedance during cycling, and thus improving the cycling performance of the electrochemical apparatus.

The first coating layer includes the lithium-containing material and the Dᵥ99 and specific surface area of the lithium-containing material are controlled within the ranges provided in this application, so that the lithium-containing material can serve as a lithium source to supplement active lithium lost due to formation of a solid electrolyte interface film (SEI film) during initial charge-discharge and active lithium consumed during cycling, improving the initial coulombic efficiency and energy density of the electrochemical apparatus and reducing cycling capacity decay, thereby improving the cycling performance. A lithium-containing material with a smaller particle size and a larger specific surface area can also form a denser and more uniform first coating layer on a surface of the positive electrode current collector to further enhance the protective effect on the positive electrode current collector during a nail penetration test, and the first coating layer wraps metal burrs that may be generated on the positive electrode current collector during the nail penetration test, reducing occurrence of internal short circuits in the electrochemical apparatus, and reducing the probability of thermal runaway caused by local overheating of the electrochemical apparatus, thereby further improving the safety performance of the electrochemical apparatus.

When the Dᵥ99 of the lithium-containing material is greater than 1000 nm, the lithium-containing material with an excessively large particle size is likely to pierce the positive electrode current collector during a nail penetration test, and excessively poor density of the first coating layer results in poor protective effect on the positive electrode current collector, increasing the probability of internal short circuits in the electrochemical apparatus, thereby affecting the safety performance of the electrochemical apparatus. When the Dᵥ99 of the lithium-containing material is less than 500 nm, the lithium-containing material is prone to agglomeration in a first coating layer slurry, resulting in poor uniformity of the first coating layer, and an excessively large contact area between the first coating layer and an electrolyte, results in excessive side reactions between the positive electrode plate and the electrolyte, thereby affecting the cycling performance of the electrochemical apparatus. When the specific surface area of the lithium-containing material is greater than 50 m²/g, a particle size of the lithium-containing material is excessively small, and agglomeration is likely to occur in the first coating layer slurry, resulting in poor uniformity of the first coating layer, and an excessively large contact area between the first coating layer and the electrolyte results in excessive side reactions between the positive electrode plate and the electrolyte, thereby affecting the cycling performance of the electrochemical apparatus. When the specific surface area of the lithium-containing material is less than 5 m²/g, the particle size of the lithium-containing material is excessively large, and the positive electrode current collector is likely to be pierced during a nail penetration test, and excessively poor density of the first coating layer results in poor protective effect on the positive electrode current collector, increasing the probability of internal short circuits in the electrochemical apparatus, thereby affecting the safety performance of the electrochemical apparatus.

Therefore, in this application, by providing the first coating layer on the positive electrode plate and controlling the Dᵥ99 and specific surface area of the lithium-containing material within the above ranges, a denser first coating layer with higher mechanical strength can be formed on a surface of the positive electrode current collector, enhancing the protective effect on the positive electrode current collector and improving the safety performance and cycling performance of the electrochemical apparatus. In this application, at least part of the surface of the lithium-containing material may be coated with carbon.

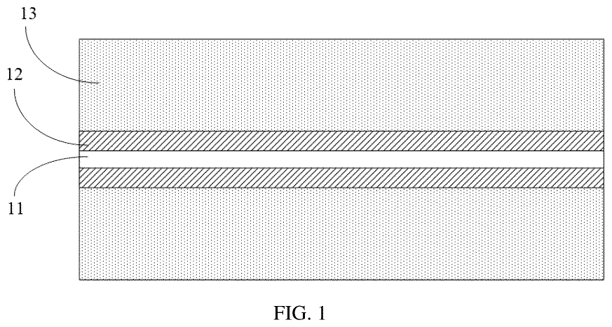

In this application, the above “the first coating layer is disposed on a surface of the positive electrode current collector” means that the first coating layer may be disposed on one surface of the positive electrode current collector in a thickness direction of the positive electrode current collector, or may be disposed on two surfaces of the positive electrode current collector in the thickness direction of the positive electrode current collector. It should be noted that the “surface” herein may be the entire region of the positive electrode current collector or a partial region of the positive electrode current collector, which is not particularly limited in this application as long as the objective of this application can be achieved. Specifically, as shown in FIG. 1, a first coating layer 12 and a positive electrode material layer 13 are sequentially stacked on two surfaces of a positive electrode current collector 11. The above “the positive electrode material layer is disposed on a surface of the first coating layer facing away from the positive electrode current collector” is understood by analogy, and the positive electrode material layer may be disposed on the entire region of the first coating layer or a partial region of the first coating layer.

In an embodiment of this application, the lithium-containing material has a Dᵥ50 of 50 nm to 200 nm. For example, the Dᵥ50 of the lithium-containing material may be 50 nm, 70 nm, 80 nm, 100 nm, 120 nm, 150 nm, 180 nm, 200 nm, or a range defined by any two of these values. When the Dᵥ50 of the lithium-containing material is within the range provided in this application, the lithium-containing material with a nanoscale particle size can serve as a lithium source to supplement active lithium lost due to formation of a SEI film during initial charge-discharge and active lithium consumed during cycling, improving the initial coulombic efficiency and energy density of the electrochemical apparatus, reducing cycling capacity decay, and also forming a denser and more uniform first coating layer on a surface of the positive electrode current collector, thereby further enhancing the protective effect on the positive electrode current collector during a nail penetration test. The first coating layer wraps metal burrs that may be generated on the positive electrode current collector during the nail penetration test, reducing occurrence of internal short circuits in the electrochemical apparatus, and reducing the probability of thermal runaway caused by local overheating of the electrochemical apparatus, thereby improving the safety performance and cycling performance of the electrochemical apparatus.

In an embodiment of this application, the lithium-containing material has a powder resistivity of 50 Ω·cm to 100 Ω·cm. For example, the powder resistivity of the lithium-containing material may be 50 Ω·cm, 60 Ω·cm, 70 Ω·cm, 80 Ω·cm, 90 Ω·cm, 100 Ω·cm, or a range defined by any two of these values. The powder resistivity of the lithium-containing material being within the range provided in this application is conducive to forming a uniform conductive network between the positive electrode material layer and the positive electrode current collector, increases short-circuit resistance generated when a short circuit occurs in the electrochemical apparatus, reduces heat generation power during a short circuit, and reduces occurrence of internal short circuits in the electrochemical apparatus, thereby improving the safety performance and cycling performance of the electrochemical apparatus.

In an embodiment of this application, the lithium-containing material includes at least one of lithium iron phosphate (LiFePO₄), lithium cobalt oxide (LiCoO₂), lithium manganese iron phosphate (LiMnₓFe₁₋ₓPO₄, 0.2≤x≤0.7), or lithium silicate (Li₂SiO₃); and based on a mass of the first coating layer, a mass percentage of the lithium-containing material is 50% to 70%. For example, the mass percentage of the lithium-containing material may be 50%, 52%, 54%, 56%, 58%, 60%, 62%, 64%, 66%, 68%, 70%, or a range defined by any two of these values. Selecting the above lithium-containing material and controlling its mass percentage within the range provided in this application is more conducive to supplementing active lithium lost due to formation of an SEI film during initial charge-discharge and active lithium consumed during cycling, improving the initial coulombic efficiency and energy density of the electrochemical apparatus, reducing cycling capacity decay, also facilitating formation of a denser and more uniform first coating layer on a surface of the positive electrode current collector, and enhancing the protective effect on the positive electrode current collector during a nail penetration test, thereby improving the safety performance and cycling performance of the electrochemical apparatus.

In an embodiment of this application, the conductive material includes at least one of SnO₂, In₂O₃, CoO, TiO₂, or Cr₂O₃; and based on the mass of the first coating layer, the mass percentage of the conductive material is 20% to 45%. For example, the mass percentage of the conductive material may be 20%, 22%, 25%, 28%, 30%, 32%, 35%, 38%, 40%, 45%, or a range defined by any two of these values. Selecting the above conductive material and controlling its mass percentage within the range provided in this application is conducive to forming a uniform conductive network between the positive electrode material layer and the positive electrode current collector, improves electron transport in the positive electrode plate, and reduces interfacial contact impedance during cycling, thereby improving the safety performance and cycling performance of the electrochemical apparatus.

In an embodiment of this application, the conductive material further includes a doping element; the doping element includes at least one of Sb, F, or B; and based on a mass of the conductive material, a mass percentage of the doping element is 0.5% to 5%, preferably 0.5% to 2%. For example, the mass percentage of the doping element may be 0.5%, 0.8%, 1%, 1.2%, 1.5%, 1.8%, 2%, 2.5%, 3%, 3.5%, 4%, 4.5%, 5%, or a range defined by any two of these values. Generally, a higher mass percentage of the doping element results in a higher preparation cost of the conductive material and a lower powder resistivity. When the doping element is applied to the first coating layer, the short-circuit resistance generated when a short circuit occurs in the electrochemical apparatus is reduced, the protective effect on the positive electrode current collector is weakened, and the safety risk increases. When the conductive material includes the above doping element and the mass percentage of the doping element is controlled within the range provided in this application, the first coating layer can protect the positive electrode current collector, reduce the powder resistivity of the conductive material, be more conducive to forming a uniform conductive network between the positive electrode material layer and the positive electrode current collector, improve electron transport in the positive electrode plate, and allow the electrochemical apparatus to have a lower preparation cost, thereby improving the safety performance and cycling performance of the electrochemical apparatus. In this application, the doping element may be added to the conductive material by adding a compound containing the doping element (for example, a chloride). during preparation of the conductive material. The mass percentage of the doping element in the conductive material can be controlled by controlling an amount of the added compound containing the doping element.

In an embodiment of this application, the conductive material has a Dᵥ50 of 50 nm to 200 nm. For example, the Dᵥ50 of the conductive material may be 50 nm, 80 nm, 100 nm, 120 nm, 150 nm, 180 nm, 200 nm, or a range defined by any two of these values. When the Dᵥ50 of the conductive material is within the range provided in this application, the conductive material with a nanoscale particle size is conducive to forming a denser and more uniform first coating layer on a surface of the positive electrode current collector, and is also conducive to forming a uniform conductive network between the positive electrode material layer and the positive electrode current collector, improving electron transport in the positive electrode plate, thereby improving the safety performance and cycling performance of the electrochemical apparatus.

In an embodiment of this application, the conductive material has a powder resistivity of 5 Ω·cm to 20 Ω·cm. For example, the powder resistivity of the conductive material may be 5 Ω·cm, 8 Ω·cm, 10 Ω·cm, 12 Ω·cm, 14 Ω·cm, 16 Ω·cm, 18 Ω·cm, 20 Ω·cm, or a range defined by any two of these values. The powder resistivity of the conductive material being within the range provided in this application is conducive to improving electron transport in the positive electrode plate, thereby improving the safety performance and cycling performance of the electrochemical apparatus.

In an embodiment of this application, the first coating layer further includes a first binder, and the first binder includes a water-soluble metal salt compound; and based on a mass of the first coating layer, a mass percentage of the first binder is 5% to 10%. For example, the mass percentage of the first binder may be 5%, 5.5%, 6%, 6.5%, 7%, 7.5%, 8%, 8.5%, 9%, 9.5%, 10%, or a range defined by any two of these values. When the above material is used for the first binder and the mass percentage of the material is within the range provided in this application, the water-soluble metal salt compound has good hydrophilicity and better electron conductivity and ion conductivity than non-water-soluble polymer binders such as polyvinylidene fluoride and polyvinyl chloride, which is conducive to electron and ion transport in the positive electrode plate. Therefore, applying the first binder to the first coating layer can improve the kinetic performance of the electrochemical apparatus and improve the cycling performance of the electrochemical apparatus. In addition, the water-soluble metal salt compound has a large specific surface area and can be highly dispersed in water, and when applied as a binder to the first coating layer, the water-soluble metal salt compound can enhance the tensile strength of the first coating layer, and strong interaction between the first coating layer and the positive electrode current collector is also conducive to enhancing adhesion force between the first coating layer and the positive electrode current collector as well as cohesion of the first coating layer, thereby improving the safety performance of the electrochemical apparatus.

In an embodiment of this application, the water-soluble metal salt compound includes an alkali metal polyacrylate salt and/or an alkaline earth metal polyacrylate salt, the alkali metal polyacrylate salt includes at least one of sodium polyacrylate, lithium polyacrylate, or potassium polyacrylate, and the alkaline earth metal polyacrylate salt includes at least one of calcium polyacrylate or magnesium polyacrylate. Selection of the above water-soluble metal salt compound is more conducive to improving electron and ion transport in the positive electrode plate, improving the kinetic performance of the electrochemical apparatus, enhancing the tensile strength of the first coating layer, and increasing adhesion force between the first coating layer and the positive electrode current collector as well as cohesion of the first coating layer through interaction with the positive electrode current collector, thereby further improving the safety performance and cycling performance of the electrochemical apparatus.

In an embodiment of this application, the first coating layer has a thickness of 0.5 μm to 2 μm, preferably 0.5 μm to 1 μm. For example, the thickness of the first coating layer may be 0.5 μm, 0.6 μm, 0.7 μm, 0.8 μm, 0.9 μm, 1 μm, 1.2 μm, 1.4 μm, 1.6 μm, 1.8 μm, 2 μm, or a range defined by any two of these values. When the thickness of the first coating layer is within the range provided in this application, the first coating layer has high mechanical strength, can protect the positive electrode current collector during a nail penetration test, reduce occurrence of internal short circuits in the electrochemical apparatus, and reduce the probability of thermal runaway caused by local overheating of the electrochemical apparatus. In addition, the positive electrode plate has low resistance, which is conducive to electron transport in the positive electrode plate, thereby improving the safety performance and cycling performance of the electrochemical apparatus while the electrochemical apparatus has high volumetric energy density.

In an embodiment of this application, the first coating layer has a porosity of 10% to 20%. For example, the porosity of the first coating layer may be 10%, 12%, 14%, 15%, 16%, 18%, 20%, or a range defined by any two of these values. When the porosity of the first coating layer is within the range provided in this application, the first coating layer formed on a surface of the positive electrode current collector is relatively dense and uniform, which can enhance the protective effect on the positive electrode current collector during a nail penetration test, reduce occurrence of internal short circuits in the electrochemical apparatus, and is also conducive to electron and ion transport in the positive electrode plate, thereby improving the safety performance and cycling performance of the electrochemical apparatus.

In an embodiment of this application, an adhesion force between the first coating layer and the positive electrode current collector is 500 N/m to 2000 N/m, preferably 500 N/m to 1000 N/m. For example, the adhesion force between the first coating layer and the positive electrode current collector may be 500 N/m, 600 N/m, 700 N/m, 800 N/m, 900 N/m, 1000 N/m, 1200 N/m, 1500 N/m, 1800 N/m, 2000 N/m, or a range defined by any two of these values. Generally, a larger adhesion force between the first coating layer and the positive electrode current collector indicates a larger percentage of the first binder in the first coating layer, which affects dispersibility of a first coating layer slurry, resulting in poor coating effect; and poor uniformity of distribution of components in the first coating layer affect the safety performance and cycling performance of the electrochemical apparatus. When the adhesion force between the first coating layer and the positive electrode current collector is within the range provided in this application, the percentage of the first binder in the first coating layer slurry is relatively small, which can improve the dispersibility of the first coating layer slurry and achieve a good coating effect, so that the components in the first coating layer are uniformly distributed, good adhesion is achieved between the first coating layer and the positive electrode current collector, and the first coating layer can wrap metal burrs that may be generated in the positive electrode current collector under abnormal conditions such as nail penetration and impact, reducing occurrence of internal short circuits in the electrochemical apparatus, and reducing the probability of thermal runaway or overheating combustion of the electrochemical apparatus due to local overheating, thereby improving the safety performance of the electrochemical apparatus. In addition, since a positive electrode active material in the positive electrode material layer experiences volume expansion during cycling, the first coating layer with a strong adhesion force can alleviate deformation of the positive electrode current collector during cycling, improve contact between the positive electrode current collector and the first coating layer and contact between the positive electrode current collector and the positive electrode material layer, and facilitate electron transport in the positive electrode plate, thereby improving the cycling performance of the electrochemical apparatus.

This application does not impose any particular limitation on a preparation method of the positive electrode plate as long as the objective of this application can be achieved. For example, preparation of the positive electrode plate may include but is not limited to the following steps: mixing a lithium-containing material, a conductive material, and a first binder at a mass ratio of (50 to 70):(20 to 45):(5 to 10), adding deionized water as a solvent, and stirring the resulting mixture uniformly to obtain a first coating layer slurry with a solid content of 70 wt % to 80 wt %. Then, the first coating layer slurry is applied onto one surface of a positive electrode current collector with a size of 5 μm to 20 μm, and dried in an oven to obtain a first coating layer with a thickness of 0.5 μm to 2 μm. Then, a positive electrode material layer slurry is prepared, and the positive electrode material layer slurry is applied onto a surface of the first coating layer, and dried to obtain a positive electrode plate having one surface coated with the first coating layer and the positive electrode material layer. The above steps are repeated on another surface of the positive electrode current collector to obtain a positive electrode plate having two surfaces coated with the first coating layer and the positive electrode material layer.

In some embodiments, a conductive material including a doping element may be purchased. In some other embodiments, a conductive material including a doping element may be prepared by the following method: TiCl₄, SnCl₄·5H₂O, and SbCl₃ are separately dissolved in deionized water, then these three solutions are mixed, and an appropriate amount of alkali (for example, NaOH) is added to adjust a pH value and facilitate precipitation formation. This solution mixture is transferred to a high-pressure reactor and reacts at 150° C. to 200° C. for several hours. After the reaction is completed, the obtained product is filtered, washed, and dried. The dried product is calcined at a high temperature of 500° C. to 800° C. for several hours to form an Sb-doped SnO₂-coated TiO₂ conductive material. A mass percentage of the doping element in the conductive material can be controlled by controlling a percentage of the compound including the doping element during preparation.

In this application, Dᵥ50 represents a particle size at which a volume-based particle size distribution reaches 50% from a small particle size side; and Dᵥ99 represents a particle size at which the volume-based particle size distribution reaches 99% from the small particle size side. The above material may be a lithium-containing material or a conductive material.

Generally, lithium-containing materials with different particle sizes and specific surface areas and conductive materials with different particle sizes may be obtained by mechanical crushing (for example, ball milling). For example, the particle size and specific surface area of the lithium-containing material and the particle size of the conductive material can be controlled by controlling a ball milling time. When other conditions remain unchanged, as the ball milling time is prolonged, the Dᵥ50 and Dᵥ99 of the lithium-containing material decrease; and as the ball milling time is shortened, the Dᵥ50 and Dᵥ99 of the lithium-containing material increase. When other conditions remain unchanged, as the ball milling time is prolonged, the specific surface area of the lithium-containing material increases; and as the ball milling time is shortened, the specific surface area of the lithium-containing material decreases. When other conditions remain unchanged, as the ball milling time is prolonged, the Dᵥ50 of the conductive material decreases; and as the ball milling time is shortened, the Dᵥ50 of the conductive material increases.

Generally, the powder resistivity of the lithium-containing material can be controlled by controlling a percentage of coating carbon. For example, when other conditions remain unchanged, as the percentage of the coating carbon increases, the powder resistivity of the lithium-containing material decreases; and as the percentage of the coating carbon decreases, the powder resistivity of the lithium-containing material increases.

Generally, the powder resistivity of the conductive material can be controlled by controlling the mass percentage of the doping element in the conductive material. For example, when other conditions remain unchanged, as the mass percentage of the doping element in the conductive material increases, the powder resistivity of the conductive material decreases; and as the mass percentage of the doping element in the conductive material decreases, the powder resistivity of the conductive material increases.

Generally, the porosity of the first coating layer can be controlled by controlling the particle sizes of the lithium-containing material and the conductive material. For example, when other conditions remain unchanged, as the particle size of the lithium-containing material increases, the porosity of the first coating layer decreases; and as the particle size of the lithium-containing material decreases, the porosity of the first coating layer increases. When other conditions remain unchanged, as the particle size of the conductive material increases, the porosity of the first coating layer decreases; and as the particle size of the conductive material decreases, the porosity of the first coating layer increases.

Generally, the thickness of the first coating layer can be controlled by controlling single-side coating weight of the first coating layer. For example, when other conditions remain unchanged, as the single-side coating weight of the first coating layer increases, the thickness of the first coating layer increases; and as the single-side coating weight of the first coating layer decreases, the thickness of the first coating layer decreases.

Lithium-containing materials with different particle sizes, specific surface areas, and powder resistivities and conductive materials with different particle sizes and powder resistivities in this application may be purchased; the particle size, specific surface area, and powder resistivity of the lithium-containing material and the particle size and powder resistivity of the conductive material are tested in combination with the test methods of “Particle size test”, “Specific surface area test”, and “Powder resistivity test” provided in this application; and lithium-containing materials with required particle sizes, specific surface areas, and powder resistivities and conductive materials with required particle sizes and powder resistivities are selected.

This application does not impose any particular limitation on the positive electrode current collector as long as the objective of this application can be achieved, for example, it may include aluminum foil, aluminum alloy foil, a composite current collector (for example, an aluminum-carbon composite current collector), or the like.

The positive electrode material layer includes a positive electrode active material. This application does not impose any particular limitation on the positive electrode active material as long as the objective of this application can be achieved. For example, the positive electrode active material may include but is not limited to at least one of lithium nickel cobalt manganese oxide (for example, NCM811, NCM622, NCM523, or NCM111), lithium nickel cobalt aluminum oxide, lithium iron phosphate, lithium-rich manganese-based material, lithium cobalt oxide (LiCoO₂), lithium manganese oxide, lithium manganese iron phosphate, or lithium titanate.

The positive electrode material layer may further include a first conductive agent and a second binder. This application does not impose any particular limitation on the types of the first conductive agent and the second binder as long as the objective of this application can be achieved. For example, the first conductive agent may include but is not limited to at least one of conductive carbon black (Super P), carbon nanotubes (CNTs), carbon fiber, flake graphite, graphene, a metal material, or a conductive polymer, and the conductive carbon black may include but is not limited to at least one of acetylene black or Ketjen black. The above carbon nanotubes may include but are not limited to single-walled carbon nanotubes and/or multi-walled carbon nanotubes. The above carbon fiber may include but is not limited to vapor-grown carbon fiber (VGCF) and/or carbon nanofiber. The above metal material may include but is not limited to metal powder and/or metal fiber, and specifically, the metal may include but is not limited to at least one of copper, nickel, aluminum, or silver. The above conductive polymer may include but is not limited to at least one of a polyphenylene derivative, polyaniline, polythiophene, polyacetylene, or polypyrrole. For example, the second binder may include but is not limited to at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamide-imide, styrene-butadiene rubber, or polyvinylidene fluoride. This application does not impose any particular limitation on a mass ratio of the positive electrode active material, the first conductive agent, and the second binder in the positive electrode material layer, and a person skilled in the art may select according to actual needs as long as the objective of this application can be achieved.

This application does not impose any particular limitation on the thickness of the positive electrode current collector as long as the objective of this application can be achieved. For example, the thickness of the positive electrode current collector is 5 μm to 10 μm. This application does not impose any particular limitation on the thickness of the positive electrode material layer as long as the objective of this application can be achieved. For example, the thickness of the positive electrode material layer is 70 μm to 90 μm.

A second aspect of this application provides an electrochemical apparatus. The electrochemical apparatus includes the positive electrode plate in any one of the foregoing embodiments. The electrochemical apparatus further includes a negative electrode plate. The negative electrode plate includes a negative electrode current collector and a negative electrode material layer disposed on at least one surface of the negative electrode current collector. The above “the negative electrode plate includes a negative electrode current collector and a negative electrode material layer disposed on at least one surface of the negative electrode current collector” means that the negative electrode material layer may be disposed on one surface of the negative electrode current collector in a thickness direction of the negative electrode current collector, or may be disposed on two surfaces of the negative electrode current collector in the thickness direction of the negative electrode current collector. It should be noted that the “surface” herein may be the entire region of the surface of the negative electrode current collector or a partial region of the surface of the negative electrode current collector, which is not particularly limited in this application as long as the objective of this application can be achieved.

This application does not impose any particular limitation on the negative electrode current collector as long as the objective of this application can be achieved, for example, it may include copper foil, copper alloy foil, nickel foil, stainless steel foil, titanium foil, foamed nickel, foamed copper, or a composite current collector. For example, the composite current collector may be a lithium-copper composite current collector, a carbon-copper composite current collector, a nickel-copper composite current collector, or a titanium-copper composite current collector.

The negative electrode material layer includes a negative electrode active material. This application does not impose any particular limitation on the negative electrode active material as long as the objective of this application can be achieved. For example, the negative electrode active material may include but is not limited to at least one of natural graphite, artificial graphite, mesocarbon microbeads, hard carbon, soft carbon, silicon, a silicon-carbon composite, an Li—Sn alloy, an Li—Sn—O alloy, Sn, SnO, SnO₂, spinel-structured lithiated TiO₂—Li₄Ti₅O₁₂, or an Li—Al alloy.

In some embodiments of this application, the negative electrode material layer may further include a second conductive agent and a third binder. For example, at least one of the above first conductive agent and the above second binder may be used. This application does not impose any particular limitation on a mass ratio of the negative electrode active material, the second conductive agent, and the third binder in the negative electrode material layer, and a person skilled in the art may select according to actual needs as long as the objective of this application can be achieved.

This application does not impose any particular limitation on the thickness of the negative electrode material layer and the thickness of the negative electrode current collector as long as the objective of this application can be achieved. For example, the thickness of the negative electrode material layer is 80 μm to 100 μm, and the thickness of the negative electrode current collector is 4 μm to 15 μm.

Optionally, the negative electrode plate may further include a conductive layer, and the conductive layer is located between the negative electrode current collector and the negative electrode material layer. This application does not impose any particular limitation on the composition of the conductive layer, and it may be a conductive layer commonly used in the art. For example, the conductive layer includes a conductive layer conductive agent and a conductive layer binder. This application does not impose any particular limitation on the conductive layer conductive agent and the conductive layer binder in the conductive layer. For example, at least one of the above first conductive agent and the above second binder may be used.

In this application, the electrochemical apparatus further includes a separator. This application does not impose any particular limitation on the separator as long as the objective of this application can be achieved. For example, the material of the separator may include but is not limited to at least one of polyolefin (PO) mainly including polyethylene (PE) or polypropylene (PP), polyester (for example, a polyethylene terephthalate (PET) film), cellulose, polyimide (PI), polyamide (PA), spandex, or aramid. The type of the separator may include at least one of a woven film, a non-woven film, a microporous film, a composite film, a calendered film, or a spun film.

In some embodiments of this application, the separator may include a substrate layer and a surface treatment layer. The substrate layer may be a non-woven fabric or composite film with a porous structure, and the material of the substrate layer may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used.

Optionally, a surface treatment layer is disposed on at least one surface of the substrate layer, and the surface treatment layer may be a polymer layer or an inorganic material layer, or a layer formed by mixing a polymer and an inorganic material.

In some embodiments of this application, the inorganic material layer includes ceramic particles and an inorganic material layer binder. This application does not impose any particular limitation on the ceramic particles, for example, the ceramic particles may include at least one of silicon oxide, magnesium oxide, titanium oxide, hafnium dioxide, tin dioxide, cerium dioxide, nickel oxide, zinc oxide, calcium oxide, zirconium oxide, yttrium oxide, silicon carbide, aluminum hydroxide, magnesium hydroxide, calcium hydroxide, or barium sulfate. This application does not impose any particular limitation on the inorganic material layer binder, for example, the inorganic material layer binder may be at least one of the above second binders. In some embodiments of this application, the polymer layer includes a polymer, and the material of the polymer includes at least one of polyamide, polyacrylonitrile, an acrylate polymer, polyacrylic acid, a polyacrylate salt, polyvinylpyrrolidone, polyvinyl ether, polyvinylidene fluoride, or poly(vinylidene fluoride-hexafluoropropylene).

In this application, the thickness of the separator is not particularly limited as long as the objective of this application can be achieved, for example, the thickness of the separator may be 3 μm to 30 μm.

In this application, the electrochemical apparatus further includes an electrolyte, and the electrolyte includes a lithium salt and a non-aqueous solvent.

This application does not impose any particular limitation on the lithium salt as long as the objective of this application can be achieved. For example, the lithium salt may include but is not limited to at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalate)borate (LiBOB), or lithium difluoroborate. This application does not impose any particular limitation on the percentage of the lithium salt in the electrolyte as long as the objective of this application can be achieved.

This application does not impose any particular limitation on the non-aqueous solvent as long as the objective of this application can be achieved, for example, the non-aqueous solvent may include but is not limited to at least one of a carbonate compound, a carboxylate compound, an ether compound, or other organic solvents.

The above carbonate compound may include but is not limited to at least one of a chain carbonate compound, a cyclic carbonate compound, or a fluorinated carbonate compound. The above chain carbonate compound may include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The above cyclic carbonate compound may include but is not limited to at least one of ethylene carbonate (EC), propylene carbonate (PC), butylene carbonate (BC), or vinyl ethylene carbonate (VEC). The fluorinated carbonate compound may include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The above carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The above ether compound may include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above other organic solvents may include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. This application does not impose any particular limitation on the percentage of the non-aqueous solvent in the electrolyte as long as the objective of this application can be achieved.

The electrochemical apparatus further includes a housing for accommodating the positive electrode plate, the separator, the negative electrode plate, the electrolyte, and other components known in the field of electrochemical apparatuses, and this application does not impose any limitation on the above other components. This application does not impose any particular limitation on the housing, and the housing may be a housing well known in the art as long as the objective of this application can be achieved. For example, the housing may be a hard housing or a soft housing. The hard housing may be made of metal, and this application does not impose any limitation on the type of metal, and a metal hard housing known in the art may be used as long as the objective of this application can be achieved. The soft housing may be a metal plastic film, for example, an aluminum plastic film or a steel plastic film.

A preparation process of the electrochemical apparatus in this application is well known to those skilled in the art, and this application does not impose any particular limitation thereon. For example, the preparation process of the electrochemical apparatus may include but is not limited to the following steps: stacking a positive electrode plate, a separator, and a negative electrode plate in sequence, and winding or folding them as required to obtain an electrode assembly of a wound structure, placing the electrode assembly in a housing, injecting an electrolyte into the housing, and sealing the housing to obtain an electrochemical apparatus; alternatively, stacking a positive electrode plate, a separator, and a negative electrode plate in sequence, and then fixing four corners of the entire stacked structure with tapes to obtain an electrode assembly of a stacked structure, placing the electrode assembly in a housing, injecting an electrolyte into the housing, and sealing the housing to obtain an electrochemical apparatus. In addition, an overcurrent prevention element, a guide plate, and the like may be placed in the housing as required, thereby preventing pressure rise, overcharge, and overdischarge inside the electrochemical apparatus.

A third aspect of this application provides an electronic apparatus. The electronic apparatus includes the electrochemical apparatus in any one of the foregoing embodiments. The electronic apparatus of this application has a long service life and excellent performance.

The electronic apparatus of this application is not particularly limited, and it may be any electronic apparatus known in the prior art. In some embodiments, the electronic apparatus may include but is not limited to a notebook computer, a pen input type computer, a mobile computer, an electronic book player, a portable telephone, a portable fax machine, a portable copier, a portable printer, a stereo headset, a video recorder, a liquid crystal television, a portable cleaner, a portable CD player, a mini disc, a transceiver, an electronic organizer, a calculator, a memory card, a portable recorder, a radio, a backup power supply, a motor, an automobile, a motorcycle, a power-assisted bicycle, a bicycle, a lighting fixture, a toy, a game console, a clock, an electric tool, a flash lamp, a camera, a large household storage battery, and a lithium-ion capacitor.

### EXAMPLES

The following provides more detailed description of some embodiments of this application with reference to examples and comparative examples. Various tests and evaluations were performed according to the following methods. In addition, unless otherwise specified, “part” and “%” are based on mass.

### Test Methods and Devices:

### Particle Size Test

A Malvern particle size tester (model: MasterSizer 2000) was used to test Dᵥ50 and Dᵥ99 of a lithium-containing material and Dᵥ50 of a conductive material. Specific tests were performed in accordance with the national standard GB/T19077-2016 Particle Size Distribution Laser Diffraction Method.

### Specific Surface Area Test

A specific surface area analyzer (Tristar II 3020M) was used to test the specific surface area of the lithium-containing material by a nitrogen adsorption method. A specific test was performed in accordance with the national standard GB/T 19587-2017 Determination of Specific Surface Area of Solids by Gas Adsorption BET Method.

### Powder Resistivity Test

A lithium-containing material powder sample or a conductive material powder sample was uniformly compacted in a mold to form a cylindrical sample with a flat surface. A four-probe method was used to test resistivity of the sample. Four probes arranged in a straight line were mounted on the sample, where two were current probes for inputting current into the sample, the other two were voltage probes for measuring a voltage drop caused by the current passing through the sample, and the voltage probes were located in the center of the sample. A constant direct current was applied to the sample through the current probes. When the current passes through the sample, a voltage drop across two ends of the sample was measured using the voltage probes. The resistivity R of the sample was calculated based on the measured current and voltage values according to Ohm's law. Then, the resistivity of the sample was calculated based on geometric dimensions of the sample through the following formula: resistivity=(resistance×cross-sectional area)/length, where for the cylindrical sample, the above cross-sectional area refers to an area of a bottom circle, and the above length refers to a height of the cylindrical sample. Measurement was performed 3 times and an average value was taken as the powder resistivity of the lithium-containing material or the conductive material.

### Thickness Test

A lithium-ion battery was discharged at a constant current of 0.1 C to 3.0 V, and the lithium-ion battery was disassembled to obtain a positive electrode plate. The positive electrode plate was cleaned with dimethyl carbonate (DMC) for 10 min, and then the positive electrode plate was baked at 100° C. for 2 h for later use. The positive electrode plate was cut, and a cross section of the positive electrode plate in a thickness direction was polished with argon ions. Then, a scanning electron microscope (OXFORD·EDS) was used to observe and measure thicknesses of the first coating layer at three positions, and an average value was taken as the thickness of the first coating layer.

### Porosity Test

A lithium-ion battery was discharged at a constant current of 0.1 C to 3.0 V, and the lithium-ion battery was disassembled to obtain a positive electrode plate. The positive electrode plate was cleaned with dimethyl carbonate (DMC) for 10 min, and then the positive electrode plate was baked at 100° C. for 2 h for later use. The positive electrode material layer was scraped off to obtain a positive electrode current collector with a surface coated with a first coating layer. A porosity analyzer was used to test the porosity of the first coating layer by mercury porosimetry. A specific porosity test was performed in accordance with the national standard GB/T 21650.1-2008 Determination of Pore Size Distribution and Porosity of Solid Materials by Mercury Porosimetry and Gas Adsorption Method Part 1: Mercury Porosimetry.

### Adhesion Force Test

A positive electrode plate coated with only the first coating layer was taken, the positive electrode plate was adhered to a smooth steel plate with a double-sided tape, an adhesive tape was adhered to another side of the positive electrode plate, and one end of the tape was fixed to a tensile machine with a speed set to 10 mm/min. The adhesive tape was pulled straight at 180° with the tensile machine, an adhesion force during stretching of the adhesive tape was read, and the data was exported and divided by a width of the adhesive tape to obtain the adhesion force between the first coating layer and the positive electrode current collector.

### Cycling Performance Test

A lithium-ion battery was left standing in an environment of 45° C.±3° C. for 30 min, then charged at a constant current of 1.25 C to 4.25 V, then charged at a constant current of 1.5 C to 4.5 V, then charged at a constant voltage of 4.5 V to 0.05 C, left standing for 30 min, and then discharged at a constant current of 0.7 C to 3.0 V. A discharge capacity obtained in this step was an initial capacity. The above cycling was repeated, a ratio of a discharge capacity of each cycle to the initial capacity was taken to obtain a discharge capacity retention rate of each cycle, and the number of cycles when the lithium-ion battery was cycled at 45° C.±3° C. until the discharge capacity retention rate was 80% was recorded. The cycling performance of the lithium-ion battery was characterized by the number of cycles after the lithium-ion battery was cycled at 45° C.±3° C. to reach a capacity retention rate of 80%. A larger number of the cycles when the lithium-ion battery was cycled at 45° C.±3° C. to reach the capacity retention rate of 80% indicates better cycling performance of the lithium-ion battery.

### Nail Penetration Test

10 lithium-ion batteries in each of the examples and comparative examples were taken and fully charged in an environment of 25±3° C. according to the specific steps as follows: each battery was charged at a constant current of 0.5 C to 4.5 V, and then charged at a constant voltage of 4.5 V to a current of 0.05 C.

A nail penetration test was performed on the lithium-ion batteries at 25±3° C., where a steel nail with a diameter of 4 mm and made of carbon steel was used, which had a taper of 16.5 mm and a total length of 100 mm; a nail penetration speed was 30 mm/s, and a nail penetration depth was required to ensure that the taper of the steel nail is greater than the length of the lithium-ion battery. The state of the lithium-ion batteries during the test was observed, no combustion or explosion of the lithium-ion batteries was taken as a pass criterion for the nail penetration test, and the number of the lithium-ion batteries that passed the nail penetration test was recorded. The safety performance of the lithium-ion batteries was characterized by a nail penetration test pass rate. A higher nail penetration test pass rate indicates better safety performance of the lithium-ion batteries.

### Example 1

### <Preparation of Positive Electrode Plate>

Lithium iron phosphate as a lithium-containing material, ball-milled SnO₂ (AM-SnO₂-028-2, provided by Zhejiang Yamei Nano Technology Co., Ltd.) as a conductive material, and sodium polyacrylate as a first binder were mixed at a mass ratio of 60:32:8, deionized water was added as a solvent, the mixture was stirred uniformly to obtain a first coating layer slurry with a solid content of 75 wt %, and the slurry was applied onto one surface of an 8 μm positive electrode current collector aluminum foil and dried in an oven to obtain a first coating layer with a thickness of 1 μm. Lithium cobalt oxide as a positive electrode active material, conductive carbon black as a first conductive agent, and polyvinylidene fluoride as a second binder were mixed at a mass ratio of 97.3:1.1:1.6, N-methylpyrrolidone (NMP) was added as a solvent, and the mixture was stirred uniformly in a vacuum mixer to obtain a positive electrode material layer slurry with a solid content of 75 wt %. The positive electrode material layer slurry was uniformly applied onto a surface of the first coating layer, and dried at 120° C. to obtain a positive electrode plate having one surface coated with the first coating layer and the positive electrode material layer, where a coating weight of the positive electrode material layer on a single surface was 267.8 mg/1540 mm². Then, the above steps were repeated on another surface of the aluminum foil to obtain a positive electrode plate having two surfaces coated with the first coating layer and the positive electrode material layer, followed by cold pressing, cutting, and tab welding to obtain a positive electrode plate with a specification of 74 mm×867 mm for later use. The thickness of the positive electrode material layer on a single surface was 80 μm, and the Dᵥ50, Dᵥ99, specific surface area, and powder resistivity of the lithium-containing material, the Dᵥ50 and powder resistivity of the conductive material, and the porosity of the first coating layer are shown in Table 1.

### <Preparation of Negative Electrode Plate>

Artificial graphite as a negative electrode active material, styrene-butadiene rubber (SBR) as a third binder, and carboxymethyl cellulose (CMC) were mixed at a mass ratio of 97.7:1:1.3, then deionized water was added as a solvent to prepare a slurry with a solid content of 70 wt %, and the slurry was stirred uniformly in a vacuum mixer to obtain a negative electrode slurry. The negative electrode slurry was uniformly applied onto one surface of a 6 μm thick negative electrode current collector copper foil, and dried at 120° C. to obtain a negative electrode plate having one surface coated with a negative electrode material layer, where a coating weight of the negative electrode material layer on a single surface was 142 mg/1540 mm². Then, the above steps were repeated on another surface of the copper foil to obtain a negative electrode plate having two surfaces coated with the negative electrode material layer, followed by drying at 120° C., cold pressing, cutting, and tab welding to obtain a negative electrode plate with a specification of 78 mm×875 mm for later use. The thickness of the negative electrode material layer on a single surface was 85 μm.

### <Preparation of Electrolyte>

In an argon atmosphere glove box with a water content of less than 10 ppm, carbonate compounds ethylene carbonate (EC), propylene carbonate (PC), and diethyl carbonate (DEC) were uniformly mixed at a mass ratio of 10:30:60 to obtain a base solvent, LiPF₆ as a lithium salt was added, and the resulting mixture was stirred uniformly to obtain an electrolyte. Based on a total mass of the electrolyte, a mass percentage of the lithium salt LiPF₆ was 12.5%, and the balance was the base solvent.

### <Separator>

A polyethylene porous polymer film with a thickness of 8 μm (manufacturer: Celgard Separator Co., Ltd., USA) was used as a separator.

### <Preparation of Lithium-Ion Battery>

The positive electrode plate, the separator, and the negative electrode plate were stacked in sequence, with the separator positioned between the positive electrode plate and the negative electrode plate for isolation, and then wound to obtain an electrode assembly. The electrode assembly was placed in an aluminum plastic film packaging bag, and dehydrated at 80° C.; and the prepared electrolyte was injected, followed by processes such as vacuum sealing, standing, formation, and shaping to obtain a lithium-ion battery, where an upper limit voltage for the formation was 4.53 V, a formation temperature was 85° C., and a formation time was 45 min to 60 min.

### Examples 2 to 25

These examples were the same as Example 1 except that corresponding preparation parameters were adjusted according to Table 1. The Dᵥ50, Dᵥ99, and specific surface area of the lithium-containing material were controlled by controlling the ball milling time of the lithium-containing material, the Dᵥ50 of the conductive material was controlled by controlling the ball milling time of the conductive material, the thickness of the first coating layer was controlled by controlling the coating weight of a single surface of the first coating layer, and the powder resistivity of the lithium-containing material was controlled by controlling the percentage of the coating carbon.

### Example 26

This example was the same as Example 1 except that in <Preparation of positive electrode plate>, a ball-milled conductive material including a doping element (AM-ATO-038-2, provided by Zhejiang Yamei Nano Technology Co., Ltd.) was used.

### Examples 27 to 32

These examples were the same as Example 26 except that corresponding preparation parameters were adjusted according to Table 1.

### Comparative Examples 1 and 2

These comparative examples were the same as Example 1 except that corresponding preparation parameters were adjusted according to Table 1. The Dᵥ50, Dᵥ99, and specific surface area of the lithium-containing material were controlled by controlling the ball milling time of the lithium-containing material.

### Comparative Examples 3 and 4

These comparative examples were the same as Example 28 except that corresponding preparation parameters were adjusted according to Table 1. The Dᵥ50, Dᵥ99, and specific surface area of the lithium-containing material were controlled by controlling the ball milling time of the lithium-containing material.

### Comparative Example 5

This comparative example was the same as Example 1 except that the following preparation method was used for the <Preparation of positive electrode plate>.

### <Preparation of Positive Electrode Plate>

Lithium cobalt oxide as a positive electrode active material, conductive carbon black as a first conductive agent, and polyvinylidene fluoride as a second binder were mixed at a mass ratio of 97.3:1.1:1.6, N-methylpyrrolidone (NMP) was added as a solvent, and the mixture was stirred uniformly in a vacuum mixer to obtain a positive electrode material layer slurry with a solid content of 75 wt %. The positive electrode material layer slurry was uniformly applied onto one surface of an 8 μm positive electrode current collector aluminum foil, and dried at 120° C. to obtain a positive electrode plate having one surface coated with a positive electrode material layer, where a coating weight of a single surface of the positive electrode material layer was 267.8 mg/1540 mm². Then, the above steps were repeated on another surface of the aluminum foil, and drying was performed at 120° C. to obtain a positive electrode plate having two surfaces coated with the positive electrode material layer, followed by cold pressing, cutting, and tab welding to obtain a positive electrode plate with a specification of 74 mm×867 mm for later use. The thickness of the positive electrode material layer on a single surface was 80 μm.

### Comparative Examples 6 and 7

These comparative examples were the same as Example 1 except that corresponding preparation parameters were adjusted according to Table 1.

Preparation parameters and performance parameters of the examples and comparative examples are shown in Table 1.

TABLE 1

| | | | | | | Mass | | | | | | Mass | | | | | | Number | |
|---|---|---|---|---|---|---|---|---|---|---|---|---|---|---|---|---|---|---|---|
| | | | | | | percentage | | | | | | percent- | | Mass | | | Adhesion | of | |
| | | | | | | of | | | | | | age | | percent- | | | force | cycles | |
| | | | | | | lithium- | | | | | Mass | of | | age | | | between | at | |
| | | | | | | containing | | | | Type | percentage | conduc- | | of | | | first | 45° C. | |
| | | | | Specific | | material | | | | of | of | tive | | first | Thick- | Poros- | coating | until | |
| | | Dᵥ50 | Dᵥ99 | surface | Powder | based | | Dᵥ50 | Powder | doping | doping | material | | binder | ness | ity | layer and | capacity | Nail |
| | Type | of | of | area | resistivity | on | Type | of | resistivity | element | element | based | | based | of | of | positive | retention | pene- |
| | of | lithium- | lithium- | of lithium- | of lithium- | first | of | conduc- | of | in | based on | on first | Type | on first | first | first | electrode | rate | tration |
| | lithium- | containing | containing | containing | containing | coating | conduc- | tive | conductive | conduc- | conductive | coating | of | coating | coating | coating | current | is | test |
| | containing | material | material | material | material | layer | tive | material | material | tive | material | layer | first | layer | layer | layer | collector | 80% | pass |
| | material | (nm) | (nm) | (m²/g) | (Ω · cm) | (%) | material | (nm) | (Ω · cm) | material | (%) | (%) | binder | (%) | (μm) | (%) | (N/m) | (cycle) | rate |
| Example 1 | Lithium | 100 | 600 | 40 | 75 | 60 | SnO₂ | 100 | 10 | / | / | 32 | Sodium | 8 | 1 | 18 | 1000 | 860 | 10/10 |
| | iron | | | | | | | | | | | | poly- | | | | | | |
| | phosphate | | | | | | | | | | | | acrylate | | | | | | |
| Example 2 | Lithium | 50 | 500 | 50 | 75 | 60 | SnO₂ | 100 | 10 | / | / | 32 | Sodium | 8 | 1 | 20 | 1200 | 858 | 10/10 |
| | iron | | | | | | | | | | | | poly- | | | | | | |
| | phosphate | | | | | | | | | | | | acrylate | | | | | | |
| Example 3 | Lithium | 120 | 700 | 30 | 75 | 60 | SnO₂ | 100 | 10 | / | / | 32 | Sodium | 8 | 1 | 15 | 900 | 862 | 10/10 |
| | iron | | | | | | | | | | | | poly- | | | | | | |
| | phosphate | | | | | | | | | | | | acrylate | | | | | | |
| Example 4 | Lithium | 180 | 800 | 20 | 75 | 60 | SnO₂ | 100 | 10 | / | / | 32 | Sodium | 8 | 1 | 12 | 800 | 855 | 9/10 |
| | iron | | | | | | | | | | | | poly- | | | | | | |
| | phosphate | | | | | | | | | | | | acrylate | | | | | | |
| Example 5 | Lithium | 200 | 1000 | 5 | 75 | 60 | SnO₂ | 100 | 10 | / | / | 32 | Sodium | 8 | 1 | 10 | 700 | 848 | 9/10 |
| | iron | | | | | | | | | | | | poly- | | | | | | |
| | phosphate | | | | | | | | | | | | acrylate | | | | | | |
| Example 6 | Lithium | 100 | 600 | 40 | 75 | 60 | SnO₂ | 10 | 10 | / | / | 32 | Sodium | 8 | 1 | 25 | 1150 | 823 | 10/10 |
| | iron | | | | | | | | | | | | poly- | | | | | | |
| | phosphate | | | | | | | | | | | | acrylate | | | | | | |
| Example 7 | Lithium | 100 | 600 | 40 | 75 | 60 | SnO₂ | 50 | 10 | / | / | 32 | Sodium | 8 | 1 | 20 | 1050 | 859 | 10/10 |
| | iron | | | | | | | | | | | | poly- | | | | | | |
| | phosphate | | | | | | | | | | | | acrylate | | | | | | |
| Example 8 | Lithium | 100 | 600 | 40 | 75 | 60 | SnO₂ | 150 | 10 | / | / | 32 | Sodium | 8 | 1 | 16 | 885 | 862 | 10/10 |
| | iron | | | | | | | | | | | | poly- | | | | | | |
| | phosphate | | | | | | | | | | | | acrylate | | | | | | |
| Example 9 | Lithium | 100 | 600 | 40 | 75 | 60 | SnO₂ | 200 | 10 | / | / | 32 | Sodium | 8 | 1 | 12 | 785 | 864 | 9/10 |
| | iron | | | | | | | | | | | | poly- | | | | | | |
| | phosphate | | | | | | | | | | | | acrylate | | | | | | |
| Example 10 | Lithium | 100 | 600 | 40 | 75 | 60 | SnO₂ | 250 | 10 | / | / | 32 | Sodium | 8 | 1 | 8 | 450 | 865 | 8/10 |
| | iron | | | | | | | | | | | | poly- | | | | | | |
| | phosphate | | | | | | | | | | | | acrylate | | | | | | |
| Example 11 | Lithium | 100 | 600 | 40 | 75 | 50 | SnO₂ | 100 | 10 | / | / | 45 | Sodium | 5 | 1 | 18 | 500 | 874 | 10/10 |
| | iron | | | | | | | | | | | | poly- | | | | | | |
| | phosphate | | | | | | | | | | | | acrylate | | | | | | |
| Example 12 | Lithium | 100 | 600 | 40 | 75 | 70 | SnO₂ | 100 | 10 | / | / | 20 | Sodium | 10 | 1 | 18 | 2000 | 845 | 10/10 |
| | iron | | | | | | | | | | | | poly- | | | | | | |
| | phosphate | | | | | | | | | | | | acrylate | | | | | | |
| Example 13 | Lithium | 100 | 600 | 40 | 75 | 45 | SnO₂ | 100 | 10 | / | / | 50 | Sodium | 5 | 1 | 18 | 501 | 876 | 8/10 |
| | iron | | | | | | | | | | | | poly- | | | | | | |
| | phosphate | | | | | | | | | | | | acrylate | | | | | | |
| Example 14 | Lithium | 100 | 600 | 40 | 75 | 75 | SnO₂ | 100 | 10 | / | / | 20 | Sodium | 5 | 1 | 18 | 499 | 831 | 7/10 |
| | iron | | | | | | | | | | | | poly- | | | | | | |
| | phosphate | | | | | | | | | | | | acrylate | | | | | | |
| Example 15 | Lithium | 100 | 600 | 40 | 75 | 60 | SnO₂ | 100 | 10 | / | / | 32 | Sodium | 8 | 0.1 | 18 | 1500 | 877 | 7/10 |
| | iron | | | | | | | | | | | | poly- | | | | | | |
| | phosphate | | | | | | | | | | | | acrylate | | | | | | |
| Example 16 | Lithium | 100 | 600 | 40 | 75 | 60 | SnO₂ | 100 | 10 | / | / | 32 | Sodium | 8 | 0.5 | 18 | 1200 | 875 | 10/10 |
| | iron | | | | | | | | | | | | poly- | | | | | | |
| | phosphate | | | | | | | | | | | | acrylate | | | | | | |
| Example 17 | Lithium | 100 | 600 | 40 | 75 | 60 | SnO₂ | 100 | 10 | / | / | 32 | Sodium | 8 | 0.8 | 18 | 1100 | 870 | 10/10 |
| | iron | | | | | | | | | | | | poly- | | | | | | |
| | phosphate | | | | | | | | | | | | acrylate | | | | | | |
| Example 18 | Lithium | 100 | 600 | 40 | 75 | 60 | SnO₂ | 100 | 10 | / | / | 32 | Sodium | 8 | 2 | 18 | 900 | 855 | 10/10 |
| | iron | | | | | | | | | | | | poly- | | | | | | |
| | phosphate | | | | | | | | | | | | acrylate | | | | | | |
| Example 19 | Lithium | 100 | 600 | 40 | 75 | 60 | SnO₂ | 100 | 10 | / | / | 32 | Sodium | 8 | 3 | 18 | 700 | 810 | 10/10 |
| | iron | | | | | | | | | | | | poly- | | | | | | |
| | phosphate | | | | | | | | | | | | acrylate | | | | | | |
| Example 20 | Lithium | 100 | 600 | 40 | 20 | 60 | SnO₂ | 100 | 10 | / | / | 32 | Sodium | 8 | 1 | 18 | 1001 | 873 | 8/10 |
| | iron | | | | | | | | | | | | poly- | | | | | | |
| | phosphate | | | | | | | | | | | | acrylate | | | | | | |
| Example 21 | Lithium | 100 | 600 | 40 | 50 | 60 | SnO₂ | 100 | 10 | / | / | 32 | Sodium | 8 | 1 | 18 | 1002 | 870 | 9/10 |
| | iron | | | | | | | | | | | | poly- | | | | | | |
| | phosphate | | | | | | | | | | | | acrylate | | | | | | |
| Example 22 | Lithium | 100 | 600 | 40 | 100 | 60 | SnO₂ | 100 | 10 | / | / | 32 | Sodium | 8 | 1 | 18 | 999 | 858 | 10/10 |
| | iron | | | | | | | | | | | | poly- | | | | | | |
| | phosphate | | | | | | | | | | | | acrylate | | | | | | |
| Example 23 | Lithium | 100 | 600 | 40 | 150 | 60 | SnO₂ | 100 | 10 | / | / | 32 | Sodium | 8 | 1 | 18 | 1003 | 795 | 10/10 |
| | iron | | | | | | | | | | | | poly- | | | | | | |
| | phosphate | | | | | | | | | | | | acrylate | | | | | | |
| Example 24 | Lithium | 100 | 600 | 40 | 70 | 60 | SnO₂ | 100 | 10 | / | / | 32 | Sodium | 8 | 1 | 18 | 989 | 861 | 10/10 |
| | cobalt | | | | | | | | | | | | poly- | | | | | | |
| | oxide | | | | | | | | | | | | acrylate | | | | | | |
| Example 25 | Lithium | 100 | 600 | 40 | 75 | 60 | SnO₂ | 100 | 10 | / | / | 32 | Calcium | 8 | 1 | 18 | 999 | 868 | 10/10 |
| | iron | | | | | | | | | | | | poly- | | | | | | |
| | phosphate | | | | | | | | | | | | acrylate | | | | | | |
| Example 26 | Lithium | 100 | 600 | 40 | 75 | 60 | SnO₂ | 100 | 9.8 | Sb | 0.1 | 32 | Sodium | 8 | 1 | 18 | 998 | 862 | 10/10 |
| | iron | | | | | | | | | | | | poly- | | | | | | |
| | phosphate | | | | | | | | | | | | acrylate | | | | | | |
| Example 27 | Lithium | 100 | 600 | 40 | 75 | 60 | SnO₂ | 100 | 9.3 | Sb | 0.5 | 32 | Sodium | 8 | 1 | 18 | 1001 | 865 | 10/10 |
| | iron | | | | | | | | | | | | poly- | | | | | | |
| | phosphate | | | | | | | | | | | | acrylate | | | | | | |
| Example 28 | Lithium | 100 | 600 | 40 | 75 | 60 | SnO₂ | 100 | 7.8 | Sb | 2 | 32 | Sodium | 8 | 1 | 18 | 1002 | 870 | 10/10 |
| | iron | | | | | | | | | | | | poly- | | | | | | |
| | phosphate | | | | | | | | | | | | acrylate | | | | | | |
| Example 29 | Lithium | 100 | 600 | 40 | 75 | 60 | SnO₂ | 100 | 5 | Sb | 5 | 32 | Sodium | 8 | 1 | 18 | 999 | 878 | 9/10 |
| | iron | | | | | | | | | | | | poly- | | | | | | |
| | phosphate | | | | | | | | | | | | acrylate | | | | | | |
| Example 30 | Lithium | 100 | 600 | 40 | 75 | 60 | SnO₂ | 100 | 3 | Sb | 7 | 32 | Sodium | 8 | 1 | 18 | 997 | 882 | 7/10 |
| | iron | | | | | | | | | | | | poly- | | | | | | |
| | phosphate | | | | | | | | | | | | acrylate | | | | | | |
| Example 31 | Lithium | 100 | 600 | 40 | 75 | 60 | SnO₂ | 100 | 7.9 | F | 2 | 32 | Sodium | 8 | 1 | 18 | 1001 | 869 | 10/10 |
| | iron | | | | | | | | | | | | poly- | | | | | | |
| | phosphate | | | | | | | | | | | | acrylate | | | | | | |
| Example 32 | Lithium | 100 | 600 | 40 | 75 | 60 | CoO | 100 | 8.0 | B | 2 | 32 | Sodium | 8 | 1 | 18 | 990 | 871 | 10/10 |
| | iron | | | | | | | | | | | | poly- | | | | | | |
| | phosphate | | | | | | | | | | | | acrylate | | | | | | |
| Comparative | Lithium | 300 | 1100 | 3 | 75 | 60 | SnO₂ | 100 | 10 | / | / | 32 | Sodium | 8 | 1 | 5 | 496 | 808 | 5/10 |
| Example 1 | iron | | | | | | | | | | | | poly- | | | | | | |
| | phosphate | | | | | | | | | | | | acrylate | | | | | | |
| Comparative | Lithium | 10 | 300 | 60 | 75 | 60 | SnO₂ | 100 | 10 | / | / | 32 | Sodium | 8 | 1 | 30 | 1250 | 780 | 10/10 |
| Example 2 | iron | | | | | | | | | | | | poly- | | | | | | |
| | phosphate | | | | | | | | | | | | acrylate | | | | | | |
| Comparative | Lithium | 10 | 300 | 60 | 75 | 60 | SnO₂ | 100 | 7.8 | Sb | 2 | 32 | Sodium | 8 | 1 | 5 | 1248 | 783 | 10/10 |
| Example 3 | iron | | | | | | | | | | | | poly- | | | | | | |
| | phosphate | | | | | | | | | | | | acrylate | | | | | | |
| Comparative | Lithium | 300 | 1100 | 3 | 75 | 60 | SnO₂ | 100 | 7.8 | Sb | 2 | 32 | Sodium | 8 | 1 | 30 | 494 | 814 | 4/10 |
| Example 4 | iron | | | | | | | | | | | | poly- | | | | | | |
| | phosphate | | | | | | | | | | | | acrylate | | | | | | |
| Comparative | / | / | / | / | / | / | / | / | / | / | / | / | / | / | / | / | / | 861 | 0/10 |
| Example 5 | | | | | | | | | | | | | | | | | | | |
| Comparative | Lithium | 200 | 1000 | 4 | 75 | 60 | SnO₂ | 100 | 10 | / | / | 32 | Sodium | 8 | 1 | 10 | 600 | 840 | 4/10 |
| Example 6 | iron | | | | | | | | | | | | poly- | | | | | | |
| | phosphate | | | | | | | | | | | | acrylate | | | | | | |
| Comparative | Lithium | 50 | 495 | 50 | 75 | 60 | SnO₂ | 100 | 10 | / | / | 32 | Sodium | 8 | 1 | 20 | 1250 | 831 | 3/10 |
| Example 7 | iron | | | | | | | | | | | | poly- | | | | | | |
| | phosphate | | | | | | | | | | | | acrylate | | | | | | |

Note:
“/” in Table 1 indicates no corresponding parameter.

It can be seen from Examples 1 to 32 and Comparative Examples 1 to 7 that when the positive electrode plate has the first coating layer structure of this application and the Dᵥ99 and specific surface area of the lithium-containing material are controlled within the ranges provided in this application, the adhesion force between the first coating layer and the positive electrode current collector is higher, and the lithium-ion battery prepared using the above positive electrode plate experiences a larger number of cycles at 45° C. until the capacity retention rate is 80% and a higher nail penetration test pass rate, indicating that the lithium-ion battery of this application has excellent cycling performance and safety performance. In the lithium-ion batteries of Comparative Examples 1 to 4, the Dᵥ99 and specific surface area of the lithium-containing material in the positive electrode plates are not within the ranges provided in this application; in Comparative Example 5, the positive electrode plate of the lithium-ion battery does not include the first coating layer; in Comparative Example 6, the specific surface area of the lithium-containing material in the positive electrode plate of the lithium-ion battery is not within the range provided in this application; and in Comparative Example 7, the Dᵥ99 of the lithium-containing material in the positive electrode plate of the lithium-ion battery is not within the range provided in this application. The lithium-ion batteries of Comparative Examples 1 to 7 experience a smaller number of cycles at 45° C. until the capacity retention rate is 80%, or a lower nail penetration test pass rate, indicating that the lithium-ion batteries cannot have both excellent cycling performance and safety performance.

The Dᵥ99 and specific surface area of the lithium-containing material generally affect the cycling performance and safety performance of the lithium-ion battery. It can be seen from Examples 1 to 5, Examples 26 to 30, Comparative Examples 1 to 4, Comparative Example 6, and Comparative Example 7 that when the Dᵥ99 and specific surface area of the lithium-containing material are within the ranges provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance. However, when the Dᵥ99 and/or specific surface area of the lithium-containing material in Comparative Examples 1 to 4, Comparative Example 6, and Comparative Example 7 are not within the ranges provided in this application, the prepared lithium-ion battery experiences a smaller number of cycles at 45° C. until the capacity retention rate is 80% or a lower nail penetration test pass rate, indicating that the lithium-ion battery cannot have both excellent cycling performance and safety performance.

The Dᵥ50 of the lithium-containing material generally affects the cycling performance and safety performance of the lithium-ion battery. It can be seen from Examples 1 to 5 that when the Dᵥ50 of the lithium-containing material is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The Dᵥ50 of the conductive material generally affects the cycling performance and safety performance of the lithium-ion battery. It can be seen from Examples 1 and 6 to 10 that when the Dᵥ50 of the conductive material is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The thickness of the first coating layer generally affects the cycling performance and safety performance of the lithium-ion battery. It can be seen from Examples 1 and 15 to 19 that when the thickness of the first coating layer is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The porosity of the first coating layer generally affects the cycling performance and safety performance of the lithium-ion battery. It can be seen from Examples 1 to 10 that when the porosity of the first coating layer is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The powder resistivity of the lithium-containing material generally affects the cycling performance and safety performance of the lithium-ion battery. It can be seen from Examples 1 and 20 to 23 that when the powder resistivity of the lithium-containing material is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The powder resistivity of the conductive material generally affects the cycling performance and safety performance of the lithium-ion battery. It can be seen from Examples 1 and 26 to 32 that when the powder resistivity of the conductive material is within the range provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The type and mass percentage of the doping element in the conductive material generally affect the cycling performance and safety performance of the lithium-ion battery. It can be seen from Examples 1 and 26 to 32 that when the type and mass percentage of the doping element in the conductive material are within the ranges provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The types and mass percentages of the lithium-containing material, the conductive material, and the first binder generally affect the cycling performance and safety performance of the lithium-ion battery. It can be seen from Examples 1 to 32 that when the types and mass percentages of the lithium-containing material, the conductive material, and the first binder are within the ranges provided in this application, the adhesion force between the first coating layer and the positive electrode current collector is higher, and the prepared lithium-ion battery experiences a larger number of cycles at 45° C. until the capacity retention rate is 80% and a higher nail penetration test pass rate, indicating that the lithium-ion battery of this application has excellent cycling performance and safety performance.

The above descriptions are merely preferred embodiments of this application and are not intended to limit this application. Any modifications, equivalent substitutions, improvements, and the like made within the spirit and principles of this application shall be included in the protection scope of this application.

It should be noted that in this specification, relational terms such as first and second are merely used to distinguish one entity or operation from another entity or operation, and do not necessarily require or imply any such actual relationship or sequence between these entities or operations. Moreover, the terms “include”, “comprise”, or any other variations thereof are intended to encompass a non-exclusive inclusion, such that a process, method, or article that includes a series of elements includes not only those elements but also other elements not expressly listed, or elements inherent to such process, method, or article.

All embodiments in this specification are described in a related manner, and identical or similar parts between these embodiments may refer to each other. Each embodiment focuses on differences from other embodiments.

What is claimed is:

1. A positive electrode plate, wherein the positive electrode plate comprises a positive electrode current collector, a first coating layer, and a positive electrode material layer; the first coating layer is disposed on a surface of the positive electrode current collector; the positive electrode material layer is disposed on a surface of the first coating layer facing away from the positive electrode current collector; the first coating layer comprises a lithium-containing material and a conductive material; the lithium-containing material has a Dᵥ99 of 500 nm to 1000 nm; and the lithium-containing material has a specific surface area of 5 m²/g to 50 m²/g.

2. The positive electrode plate according to claim 1, wherein the lithium-containing material has a Dᵥ99 of 500 nm to 700 nm.

3. The positive electrode plate according to claim 1, wherein the lithium-containing material has the specific surface area of 30 m²/g to 50 m²/g.

4. The positive electrode plate according to claim 1, wherein the lithium-containing material satisfies at least one of the following conditions:
(1) the lithium-containing material has a Dᵥ50 of 50 nm to 200 nm; or
(2) the lithium-containing material has a powder resistivity of 50 Ω·cm to 100 Ω·cm.

5. The positive electrode plate according to claim 1, wherein the lithium-containing material comprises at least one of lithium iron phosphate, lithium cobalt oxide, lithium manganese iron phosphate, or lithium silicate; and based on a mass of the first coating layer, a mass percentage of the lithium-containing material is 50% to 70%.

6. The positive electrode plate according to claim 1, wherein the conductive material comprises at least one of SnO₂, In₂O₃, CoO, TiO₂, or Cr₂O₃; and based on a mass of the first coating layer, a mass percentage of the conductive material is 20% to 45%.

7. The positive electrode plate according to claim 6, wherein the conductive material further comprises a doping element; the doping element comprises at least one of Sb, F, or B; and based on a mass of the conductive material, a mass percentage of the doping element is 0.5% to 5%.

8. The positive electrode plate according to claim 7, wherein based on the mass of the conductive material, the mass percentage of the doping element is 0.5% to 2%.

9. The positive electrode plate according to claim 1, wherein the conductive material satisfies at least one of the following conditions:
(1) the conductive material has a Dᵥ50 of 50 nm to 200 nm; or
(2) the conductive material has a powder resistivity of 5 Ω·cm to 20 Ω·cm.

10. The positive electrode plate according to claim 1, wherein the first coating layer further comprises a first binder; the first binder comprises a water-soluble metal salt compound; and based on a mass of the first coating layer, a mass percentage of the first binder is 5% to 10%.

11. The positive electrode plate according to claim 10, wherein the water-soluble metal salt compound comprises an alkali metal polyacrylate salt and/or an alkaline earth metal polyacrylate salt; the alkali metal polyacrylate salt comprises at least one of sodium polyacrylate, lithium polyacrylate, or potassium polyacrylate; and the alkaline earth metal polyacrylate salt comprises at least one of calcium polyacrylate or magnesium polyacrylate.

12. The positive electrode plate according to claim 1, wherein the first coating layer has a thickness of 0.5 μm to 2 μm, and the first coating layer has a porosity of 10% to 20%.

13. The positive electrode plate according to claim 12, wherein the first coating layer has a thickness of 0.5 μm to 1 μm.

14. The positive electrode plate according to claim 1, wherein an adhesion force between the first coating layer and the positive electrode current collector is 500 N/m to 2000 N/m.

15. The positive electrode plate according to claim 14, wherein the adhesion force between the first coating layer and the positive electrode current collector is 500 N/m to 1000 N/m.

16. An electrochemical apparatus, wherein the electrochemical apparatus comprises a positive electrode plate; wherein the positive electrode plate comprises a positive electrode current collector, a first coating layer, and a positive electrode material layer; the first coating layer is disposed on a surface of the positive electrode current collector; the positive electrode material layer is disposed on a surface of the first coating layer facing away from the positive electrode current collector; the first coating layer comprises a lithium-containing material and a conductive material; the lithium-containing material has a Dᵥ99 of 500 nm to 1000 nm; and the lithium-containing material has a specific surface area of 5 m²/g to 50 m²/g.

17. The electrochemical apparatus according to claim 16, wherein the lithium-containing material has a Dᵥ99 of 500 nm to 700 nm.

18. The electrochemical apparatus according to claim 16, wherein the lithium-containing material has the specific surface area of 30 m²/g to 50 m²/g.

19. The electrochemical apparatus according to claim 16, wherein wherein the first coating layer has a thickness of 0.5 μm to 1 μm.

20. An electronic apparatus, wherein the electronic apparatus comprises an electrochemical apparatus, wherein the electrochemical apparatus comprises a positive electrode plate; wherein the positive electrode plate comprises a positive electrode current collector, a first coating layer, and a positive electrode material layer; the first coating layer is disposed on a surface of the positive electrode current collector; the positive electrode material layer is disposed on a surface of the first coating layer facing away from the positive electrode current collector; the first coating layer comprises a lithium-containing material and a conductive material; the lithium-containing material has a Dᵥ99 of 500 nm to 1000 nm; and the lithium-containing material has a specific surface area of 5 m²/g to 50 m²/g.
